(19) United States
(12) Patent Application Publication
(10) Pub. No.: US 2013/0325704 A1
(43) Pub. Date: Dec. 5, 2013

(54) SOCIAL MEDIA AND SOCIAL NETWORKS FOR EVENT CREDENTIALING

(71) Applicant: UT-Battelle, LLC, Oak Ridge, TN (US)

(72) Inventors: Bryan L. Gorman, Knoxville, TN (US); David R. Resseguie, Knoxville, TN (US)

(73) Assignee: UT-Battelle, LLC, Oak Ridge, TN (US)

(21) Appl. No.: 13/896,970

(22) Filed: May 17, 2013

Related U.S. Application Data
(60) Provisional application No. 61/653,024, filed on May 30, 2012.

(51) Int. Cl. G06Q 50/26; G06Q 10/06

(52) U.S. Cl. CPC G06Q 50/265; G06Q 10/06
USPC 705/39; 705/325

(57) ABSTRACT

Event management includes enrolling prospective participants by associating each participant with a profile. The profile includes the participant's attributes which are vetted automatically or by social networking means. A token is assigned to each profile which enables access to the profiles. An event is created and associated with event access control rules which correspond to various attributes. Access to the event involves scanning the token, accessing a participant's profile and testing attributes in the profile relative to the access control rules. The token can be re-used at different events having different access control rules.

### CROSS REFERENCES TO RELATED APPLICATIONS

This patent application makes reference to and claims priority to U.S. Provisional Patent Application Ser. No. 61/653,024, filed on May 30, 2012, which is hereby incorporated herein by reference in its entirety.

### STATEMENT REGARDING FEDERALLY FUNDED RESEARCH AND DEVELOPMENT

This invention was made with government support under Contract No. DE-AC05-00OR22725 between UT-Battelle, LLC. and the U.S. Department of Energy. The government has certain rights in the invention.

### BACKGROUND OF THE INVENTION

1. Technical Field

The present disclosure relates to access control and more specifically to a credentialing system and method for vetting participants before allowing them access to natural and man-made events, properties and facilities.

2. Related Art

Natural disasters such as fires, tornados, floods, earth quakes, tsunamis, and hurricanes, for example, present a logistical challenge for authorities before, during, and after the events occur. The authorities may: stage equipment and personnel in anticipation of an event; identify the people who live in the immediate area of danger; and begin a relief and recovery effort as the event concludes. Individuals with specialized skills are often needed to secure or mitigate further damage to critical infrastructure, equipment and/or materials. Without a robust credentialing system and method in place, a well-coordinated and timely response may be a challenge for authorities and can lead to waste, fraud and abuse.

Other kinds of events such as visits by dignitaries, sporting events, and musical events, for example, also present a challenge for event coordinators. Authorization and access to controlled-access areas by attendees, performers, support personnel, and venue operators may need to be strictly controlled for safety reasons and/or to protect a venue against fraudulent entry. Resale of event tickets for a profit, otherwise known as ticket scalping, may also need to be addressed.

Furthermore, controlling access to facilities or properties, for example, schools, hospitals, airports, company headquarters and warehouses, may be important for the safety and security of the facility personnel, visitors and for the protection of assets. While it may be acceptable for certain employees to have unrestricted access to a facility or property, tighter access controls for visitors and for proprietary areas may be needed.

### BRIEF SUMMARY OF THE INVENTION

Disclosed are several examples of a credentialing system and method for vetting participants of events, properties and facilities to ensure they have acquired the proper credentials before being provided with access.

Event management may comprise enrolling one or more prospective participants. Each participant may be associated with a corresponding participant profile which may be stored in a device memory. Each participant profile may include one or more attributes. A unique token may be assigned to each of the participant profiles for allowing electronic access to corresponding ones of the participant profiles. A level of trust may be determined for one or more of the attributes of each of the participant profiles. An event may be created and stored in a memory device where one or more access control rules may be associated with the event. The one or more access control rules may identify one or more attributes used for allowing access to the event. Access to the event may be controlled by scanning a prospective participant's unique token with a scanning device and accessing the participant profile corresponding to the unique token. One or more of the attributes stored in the accessed participant profile may be tested relative to the one or more access control rules associated with the event.

According to one example, a method of managing an event using a network of computing devices includes the steps of: a) enrolling one or more prospective participants, each participant having one or more qualification attributes that are part of a unique participant profile that is created and stored in a memory of a computing device in the network; b) assigning a unique token to allow direct access to a unique participant profile stored in the memory; c) authenticating one or more of the qualification attributes in each unique participant profile to ensure the prospective participant has attained and/or retained the qualification attributes; d) creating an event that is stored in a memory of a computing device in the network and having an event coordinator define one or more access control rules, the rules requiring that one or more specific qualification attributes be present and authenticated in a participant profile in order for the rules to be met and for a prospective participant to be eligible for event participation; and, e) controlling access to the event by scanning a prospective participant's unique token code with a networked scanning device and matching the one or more professional attributes stored in the unique participant profile with the one or more access control rules stored for the event.

According to another example, a networked computer system for managing an event includes a processing device; a memory device in communication with the processing device, the memory device configured to store processing device executable instructions, wherein the processing device executable instructions include: an enrollment module for generating, and storing into memory, a prospective participant profile having one or more qualification attributes, the module also for generating a unique token for allowing direct access to a unique participant profile; a vetting module for verifying one or more of the qualification attributes in each unique participant profile stored in memory to ensure the prospective participant has attained and has retained the qualification attributes; an event manager module for creating an event that is stored in the memory of a computing device in the network and the event having one or more access control rules defined, the rules requiring that one or more specific qualification attributes be present and authenticated in a participant profile in order for the rules to be met and for a prospective participant to be eligible for event participation; and an access control module for controlling access to the event by scanning a prospective participant's unique token code with a networked scanning device and matching the one or more professional attributes stored in the unique participant profile with the one or more access control rules stored for the event.

A method of managing an event is disclosed, using a network of computing devices, the method comprising the steps of:
a) enrolling one or more prospective participants, with each participant having one or more qualification attributes that make up a unique participant profile that is created and stored in a memory of a computing device in the network;
b) assigning a unique token to each of the unique participant profiles stored in the memory for allowing electronic access to the profiles;
c) authenticating one or more of the qualification attributes in the unique participant profiles to ensure the prospective participants have attained and retained the qualification attributes;
d) creating an event that is stored in a memory of a computing device in the network and having an event coordinator define one or more access control rules, the rules requiring that one or more specific qualification attributes be present and authenticated in a participant's profile in order for a prospective participant to be eligible for event participation; and
e) controlling access to the event by scanning a prospective participant's unique token code with a networked scanning device and matching the one or more professional attributes stored in the unique participant profile with the one or more access control rules stored for the event.

In the method steps as recited above, a qualification attribute in the enrolling step is a photo, a name, a social security number, a street address, a company affiliation, a professional certification, a local certification, a state certification, a federal certification, a professional license, a degree, a permit, a skill or a specific piece of equipment.

In the method steps recited above, the enrolling step a) also includes purchasing a permit.

In the method steps recited above, the unique token in the assigning step is a Quick Response (QR) Code.

In the method steps recited above, the authenticating step is performed by cross referencing one or more existing databases accessible through the network.

In the method steps recited above, the authenticating step is performed by a third party vetting process through the network.

The method steps recited above further comprise a tracking step f) wherein the participant's location is tracked via a global positioning sensor.

The method steps recited above further comprise a tracking step f) wherein an event coordinator sends messages to the one or more participants.

In the method steps recited above, the event is a manmade or natural disaster.

In the method steps recited above, the event is a sporting or artistic event.

In the method steps recited above, the event is a physical facility or property.

In the method steps recited above, the controlling step e) includes displaying a unique participant profile as a mashup on a networked computing device screen.

In the method steps recited above, the creating step d) includes creating an access control rule that is time dependent.

A networked computer system for managing an event is disclosed where the computer system comprises:
a) a processing device;
b) a memory device in communication with the processing device, the memory device configured for storing processing device executable instructions, wherein the processing device executable instructions include:
c) an enrollment module for generating, and storing into memory, one or more prospective participant profiles having one or more qualification attributes, the module also for generating a unique token for allowing direct access to a unique participant profile;
d) a vetting module for verifying one or more of the qualification attributes in each unique participant profile stored in memory to ensure the prospective participant has attained and retained the qualification attributes;
e) an event manager module for creating an event that is stored in the memory of a computing device in the network and the event having one or more access control rules defined, the rules requiring that one or more specific qualification attributes be present and authenticated in a participant profile in order for the rules to be met and for a prospective participant to be eligible for event participation; and
f) an access control module for controlling access to the event by scanning a prospective participant's unique token code with a networked scanning device and matching the one or more professional attributes stored in the unique participant profile with the one or more access control rules stored for the event.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. Non-limiting and non-exhaustive descriptions are described with reference to the following drawings. The components in the figures are not necessarily to scale, emphasis instead being placed upon illustrating the principles of the invention. Moreover, in the figures, like referenced numerals designate corresponding parts throughout the different views.

FIG. 1 is a simplified schematic of a credentialing system in accordance with an example of the present invention.

FIG. 2 illustrates an exemplary participant profile in accordance with an example of the present invention.

FIG. 3 illustrates an exemplary mobile application participant mashup in accordance with an example of the present invention.

FIG. 4 is a flow diagram representing steps for managing secure access to an event.

### DETAILED DESCRIPTION OF THE PREFERRED EMBODIMENTS

The emergence on the Internet of social media web sites and social networks has significantly accelerated the discovery, proliferation, and sharing of public and private information. Some of these so-called Web 2.0 technologies may be applied in a deliberate and formal way to address challenges in credentialing and authenticating personnel and/or organizations that attend various types of events or respond to disasters, for example. Social networking may improve and enhance the flow of vetted resources to assist impacted areas and populations in the recovery and restoration of public services and operations, infrastructure, and commerce. Such a credentialing system may handle and account for large and varied numbers of people and organizations to include, for example, volunteers, residents, commercial businesses and their employees, public and private service providers, public officials, aid workers and non-governmental organizations (NGOs), first responders, and the media. Moreover, the same system may be deployed in support of daily services for routine, non-emergency information sharing activities and may be available and re-purposed for disaster credentialing during response and recovery operations.

A trusted network credentialing system may utilize existing technologies and web and mobile applications. Users and/or enterprises may be permitted to establish and augment their on-line “trustworthiness” profiles and trust networks over time and as needed. An operator of a trusted network may track, authenticate, and/or vet user and/or enterprise profiles that may be associated with their trusted network. In some systems, mobile applications may be used by participants and/or designated agents of an event or network, to access credentials, profiles, and tracking information.

A credentialing system may include a managed Internet portal with a set of services that permits users and/or enterprises to register profiles, build networks, and establish levels of trustworthiness based on self-declaration, recommendations from others and/or authenticated recommendations and certifications from approved sources such as governmental or private organizations or individuals. An identification code generation facility may enable users and/or enterprises to create, print, and/or scan Quick Response (QR) codes or barcodes, for example, that may link back to their trust network profiles. Cell phone applications may enable users to connect to a trust network by scanning a valid QR code. The users may cross check user or enterprise profiles, check-in to a restricted area, and/or post and update the activities and movements of other users and enterprises in the trusted network based on permissions.

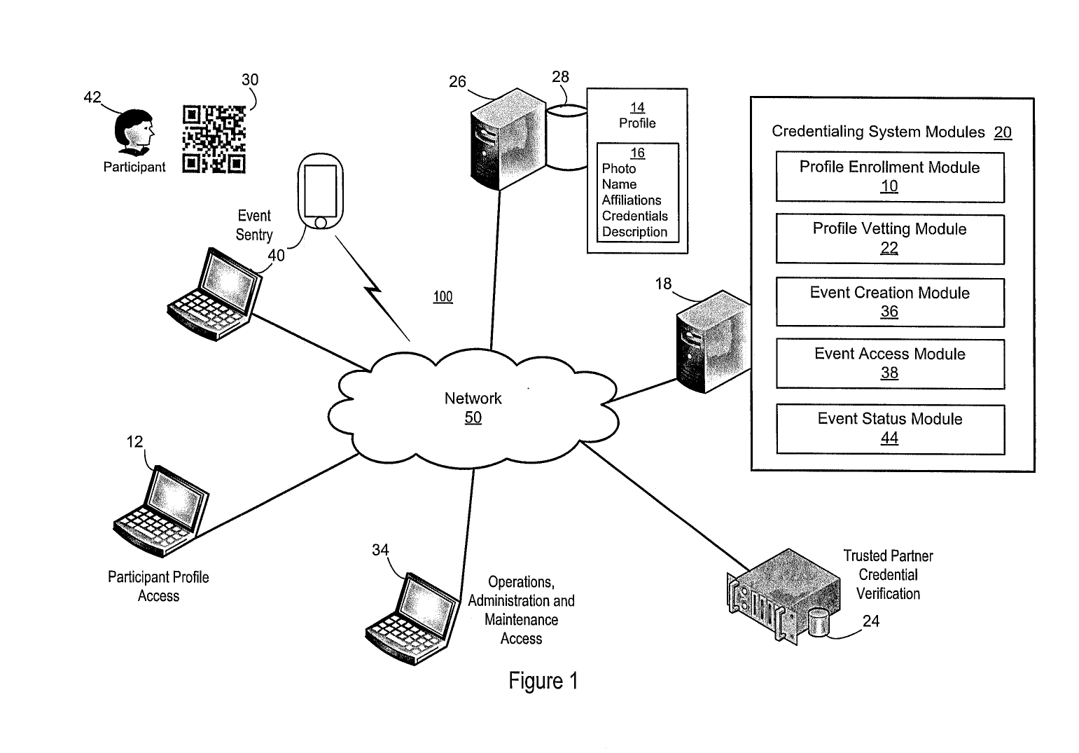

Turning to the figures, FIG. 1 comprises a trusted network credentialing system 100 which may include a computing system 26, a memory 28, a profile 14, a computing system 18 and a plurality of credentialing system modules 20. The credentialing system modules 20 may include a profile enrollment module 10, a profile vetting module 22, an event creation module 36, an event access module 38 and an event status module 44. The credentialing system 100 may comprise one or more networks 50 and one or more computing and/or communications systems 40, 12, 34 and 24.

The credentialing system 100 may be utilized to control and/or monitor access to an event by participants of the event. The event may be planned or scheduled, or it may be an ad hoc situation, for example, an emergency response event. An event may be a one-time occurrence or may occur repeatedly. In one example, an event may comprise routine or repeated access to one or more locations, for example, access to a place of employment by employees on a daily basis. The event may occur in an indoor and/or an outdoor location. Some events may be distributed over a plurality of indoor and/or outdoor locations or over one or more geographical areas. In some events, the location of the event may change over time. A person accessing or attending the event may be referred to as a participant or an attendee, for example. Moreover, other objects such as equipment, vehicles or animals that may gain access to an event utilizing the credentialing system 100, may be referred to as participants or attendees of the event.

People attending an event may have many different purposes for being at the event and may bring a great variety of skill sets. They may come from many different organizations with different credentialing and/or security systems. The present method and system provides a flexible way to control access to one event or to a plurality of events based on a plurality of different types of credentials, and to track people going into and/or out of an event. A unique token or identification (ID) assigned to each event participant may represent various existing credentials associated with a participant where some credentials may be needed to access a first event and others may be used to access another event. The credentialing system 100 may enable tracking of individuals into and/or out of an event. The tracking information may be utilized to manage operations at the event, for example, to provide safety communications to personnel attending the event or account for resources at the event. In addition to disaster response events, representative events may include sporting events, music events and festivals, for example. One representative event may include the Olympic Games where people from a variety of backgrounds such as athletes, coaches, press, security, event staff, vendors and spectators may come from different countries and different organizations to participate in different roles at the games. The event credentialing system may enable managing and tracking access to the Olympics by the many varied users based on their user profiles and corresponding self-generated access tokens. The same profiles and/or access tokens that may be used at the Olympics may be reused by the participants over time at a plurality of different events, each of which may require different credentials represented in the participant's token.

The level of control applied to participants accessing or attending an event may vary depending on the type of event. For example, in some instances, the credentialing system 100 may be utilized to limit access into and/or out of restricted areas, to participants with specified credentials. In a less restrictive event, the credentialing system 100 may be utilized to account for resources on hand at the event, for example, by identifying employees, responders, vehicles and/or equipment that are on location or available at the event. The criteria used for allowing access to an event or for monitoring aspects of the event may change over time. For example, as an event progresses, the types of resources needed, such as qualified personnel or specialized equipment, may change. The credentialing system 100 may adapt the criteria used for allowing access to the event and/or for monitoring of the event, as the event evolves.

An implementation of the credentialing system 100 may comprise a single computer system or may include any collection of systems and/or sub-systems that individually or jointly execute a set, or multiple sets, of instructions to perform any of the processing described herein.

The computing system 18 may comprise logic, which, when executed, may cause the computing system 18 to perform any of the logic and/or steps disclosed herein. The computing system 18 may operate as a standalone device or as a plurality of devices connected, for example, using a network or other connections. The computing system 18 may host the credentialing system modules 20 which may provide backend services for users of the credentialing system 100. Users of the system 100 may comprise, for example, event participants; enrollment administrators, event coordinators; credentialing system administrators, credential verification agents and credential corroboration agents. The credentialing system modules 20 may be implemented through hardware, software or firmware, or any combination thereof. Software implementations of the credentialing system modules 20 may include, but are not limited to, distributed processing or component/object distributed processing, parallel processing, mobile applications or virtual machine processing, constructed to implement the functions described herein.

In a networked deployment, the computing system 18 may operate in the capacity of a server or as a client user computer in a server-client user network environment, or as a peer computer system in a peer-to-peer or distributed network environment. In some systems, the computing system 18 may operate in a cloud computing environment. The computing system 18 may also be implemented as or incorporated into various devices, for example, a personal computer (PC), a tablet PC, a main frame computer, a set-top box (STB), a personal digital assistant (PDA), a mobile device, a palmtop computer, a laptop computer, a desktop computer, a mobile communications device, or any other machine capable of executing the credentialing system modules 20 logic that may specify actions to be taken by that machine. The computing system 18 may comprise electronic devices that provide voice, video or data communication.

The computing system 18 may be communicatively coupled to the computing system 26 and/or the memory 28, for example, via the network 50. In some systems, the memory 28 may comprise a database and the computing system 26 may be a database server. The database server 26 may host a database management system to control storage and retrieval of data in the database of the memory 28 for the credentialing system 100. The memory 28 may store one or more database structures that may be utilized to store one or more profiles such as the profile 14, event participant tracking information and/or event monitoring data. The memory 28 may be referred to as the database 28. The credentialing system modules 20 may store and/or retrieve information in the database 28.

The memory 28 may comprise a local or distributed memory, cloud computing resources, or a local or distributed database, for example. The database structure may support a database sublanguage (e.g., structured query language, for example) that may be used for querying, updating, and managing data stored in a local or distributed memory of the databases. The database may be accessible through a database engine or Application Programming Interfaces (APIs) between the database and one or more of the credentialing modules 20 that may handle requests for database actions and control database security and data integrity requirements. A cloud or cloud based computing may refer to a scalable platform that provides a combination of services including computing, durable storage of both structured and unstructured data, network connectivity and other services. Services provided by a cloud or cloud based computing may be interacted with (provisioned, de-provisioned, or otherwise controlled) by one or more APIs associated with one or more of the credentialing modules 20.

The computing system 18 may be communicatively coupled with one or more computing and/or communication devices 40, 12, 34 and 24 via the network 50, for example. The network 50 may comprise a single network or any combination of networks and network technology. Communication among the computing system 26, the computing system 18 and/or the computing and/or communication systems 40, 12, 34 and 24 is not limited with regard to any specific network or communication technology and any suitable communication technology or communication interfaces may be utilized. For example, the network 50 may comprise any suitable wireless, wired or optical networks.

The computing system 18 may comprise a web server and may be referred to as the web server 18. The web server 18 may interface with backend services provided by the credentialing system modules 20. One or more of the computing and/or communication systems 40, 12, 34 and 24 may comprise browser software that may be utilized to access services provided by the credentialing system modules 20 via the web server 18 and/or to access data, profiles and/or event information stored in the memory 28. In some systems, the computing and/or communication systems 40, 12, 34 and 24 may comprise a native application, for example, a mobile phone application or a PC application, that may interface with the backend services provided by the credentialing system modules 20 and/or the profile 14, for example.

The computing and/or communication systems 40, 12, 34 and 24 may comprise any device which is suitable to access the computing system 18, computing system 26 and/or the memory 28 via the network 50, for example. In some systems, the computing and/or communication systems 40, 12, 34 and 24 may be operable to store and/or execute one or more of the credentialing system modules 20. The computing and/or communication systems 40, 12, 34 and 24 may comprise, for example, a mobile phone, a laptop, a personal computer (PC), a tablet PC, a main frame computer, a set-top box (STB), a personal digital assistant (PDA), a palmtop computer, a communications device.

In some systems, the computing and/or communication system 40 may be utilized at an event, to screen potential participants or attendees of the event. An example of the computing and/or communication system 40 may be a mobile phone or a laptop. The computing and/or communication system 40 may comprise a sensor that can be operable to scan or read a participant's identification information, for example, a QR code, an RF ID or bar code. However, the system is not limited in this regard. The computing and/or communication system 40 may be referred to as a scanner and may comprise an automatic scanner or may be operated by a user. Attendees at an event may be referred to as participants.

The computing and/or communication system 12 may be, for example, a personal computer or mobile phone which may be utilized by a prospective, current or prior participant or an administrator in the credentialing system 100 to create and/or update the profile 14.

The computing and/or communication system 34 may be utilized an administrator of the credentialing system 100 to access the credentialing system modules 20 and create an event, create or update profiles such as the profile 14, vet profiles; configure access to an event and/or monitor an event.

The computing and/or communication system 24 may comprise a third party server and/or database that may be a trusted source for verifying information such as affiliations or credentials in the profile 14. For example, the computing and/or communication systems 24 may comprise a trusted government, employer enterprise or certification organization system which may comprise records that may be used to verify credentials and/or affiliations in the profile 14.

In some systems, the computing and/or communication system 18 may comprise suitable user interfaces such that a credentialing system 20 administrator or a participant may interact with the credentialing system modules 20 via a local user interface.

One or more of the credentialing system modules 20 may be accessed via the network 50 by one or more of the computing and/or communication systems 40, 12, 34 and 24. For example, a web browser or a native application may enable a user to interact with one or more of the credentialing system modules 20 from one or more of the computing and/or communication devices 40, 12, 24 and 24. The computing and/or communication devices 40, 12, 3 and 24 may comprise any suitable logic, circuitry, interfaces and/or code that may enable users such as prospective event participants or credentialing system 100 administrators to access, configure or utilize the credentialing system 100 and/or to manage access to an event

Participant profiles, such as the profile 14, may be created and/or vetted with or without association to an event or may be associated with one or more events. For example, one or more profiles may be created and/or vetted for individuals or groups without association to an event. In this manner, the profiles may be ready to use when an event occurs. For simplicity of expression, any individual or entity for which a profile is created may be referred to as a participant or prospective participant, for example.

The enrollment module 10 may be utilized for creating participant profiles for prospective, current and/or past event participants. For example, the enrollment module 10 may be utilized to create the profile 14 for the participant 42. The enrollment module 10 may be accessed via one or more of the computing or communication devices 18, 12, 34 or 40. For example, a prospective attendee 42 may proactively enroll in current and/or future events, the prospective attendee 42 may be invited to enroll by an event coordinator, or the prospective attendee 42 may be recruited by other attendees through social network recruitment strategies or through affiliations. In some examples, a prospective attendee 42 might be recruited by an employer or an employer may submit a list of employees for one or more profiles 14. A prospective attendee may be an individual or may be part of a group of individuals such as the entire staff of a fire department. The attendee 42 or another user, for example, an employer or event coordinator may populate the profile 14 with information about the prospective participant 42 and may enter affiliations, credentials and descriptions in the profile 14. Information may be linked into the profile 14 from another source, for example, another social media profile.

Information that may be utilized by the enrollment platform 10 for creation of an attendee profile 14 may include qualification attributes 16 such as: a photo, a name, a social security number, a street address, a company affiliation, a professional certification, a local certification, a state certification, a federal certification, a professional license, a degree, a permit, a skill or a specific piece of equipment, for example.

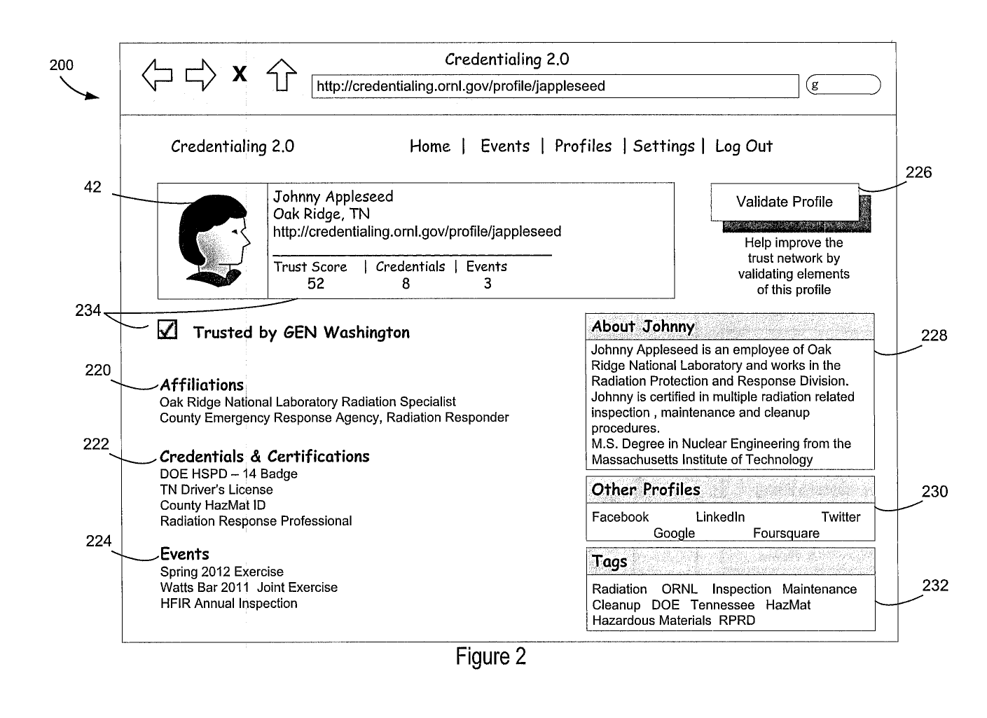

FIG. 2 illustrates an exemplary participant profile web page in accordance with an example of the present invention. In some systems 100, all or a portion of information included in the profile 14 may be represented in a user profile web page 200, it or may be represented by another type of user interface. The user profile web page 200 may be accessed using one or more of the computing and/or communication systems 18, 26, 40, 12, 34 and 24, for example. The web page 200 may comprise links 230 to related information such as other online profiles. In some systems the web page 200 may display a short user biography 228 that may be imported from another linked profile, for example. The web page 200 may comprise one or more links 226 that may activate one or more credentialing system 20 module processes, for example, for validating credentials 222 or affiliations 220 in the profile 14.

The affiliations 220 from the profile 14 may be displayed on the web page 200 and may include, for example, an employer, a cultural group, an association, an institution, or a professional society associated with the participant 42. Credentials and/or certifications 222 may be entered by a user of the system, for example, the participant 42, an employer, an event coordinator or a credentialing system administrator. In some instances, upon entry of data into the profile 14, the credentials and/or certifications may not be verified by a trusted agent and may be referred to as self-asserted or self-declared credentials until or unless they are authenticated. Credentials and/or certifications 222 may comprise, for example, an employment position, cardio pulmonary resuscitation (CPR) certification, hazardous materials (HAZMAT) training, or nuclear emergency training, however, the system is not limited with regard to any specific credentials or affiliations.

When populating the profile 14, the affiliations 220, credentials 222 or other profile information, may appear in a drop down box of a user interface for selection by a user of the system and/or they may be retrieved from the database 28 or another source, for example. In other examples, the affiliations and credentials may be entered directly by the user of the system if they are not included in the database 28 or a menu selection. In some examples, a permit may need to be obtained from a local, state or federal agency, for example, in order to access an event. The exemplary qualification attributes shown in FIG. 2 are not exhaustive and are not to be construed as limiting in any way. For privacy, a participant or a credentialing system administrator may be allowed to limit which credentials or affiliations from the profile 14, may be displayed in the user profile web page 200, for example, based on specified criteria, such as events the participant may be associated with and/or specified requirements for accessing an event. In other instances, display of Personal Identifying Information PII, such as social security number, may be masked from view. If permitted in a particular credentialing system 100, various system users may populate and/or update a profile such as the profile 14, for example, a system administrator, an event coordinator, an employer, any user on the system or a participant may create or update their own profile, information or attributes in a user's profile 14, for example, credentials, certifications, affiliations and other descriptions may be associated with a level of confidence or trust. The level of confidence or trust may relate to the authenticity of the attributes in the profile. The confidence level may be based on verified or approved authenticity corresponding with a higher or absolute confidence, or may be based on less trusted input corresponding with lower levels of confidence or rejection. For example, elements within the profile 14 or the entire profile 14 may lack credibility beyond a declaration or entry by the participant 42. A higher level of credibility or trust may be obtained for the profile 14, based on input from other users in the system corroborating the information in the profile 14. An even higher level of credibility may be obtained by authentication from a fully trusted agent or entity, for example, the third party trusted network entity 24.

Once the member profiles such as the profile 14 are prepared and/or stored in the system database 28, the vetting module 22 may review the profile 14 for accuracy and/or authenticity. The vetting module 22 may generate a level of confidence associated with the profile 14 or particular information in the profile 14. The vetting module 22 may accept or reject all or a portion of a profile 14. In some systems, an authorized user of the credentialing system 100 may access the vetting module 22 to validate information in the profile 14. Moreover, in some systems, the vetting module 22 may automatically validate the profile 14 by accessing information in the database 28 or by accessing another server and/or database 24 which may be operated by a third party.

In some systems, the vetting module 22 may be operable to automatically access the server and/or database 24 via a wired or wireless internet connection to verify information in the profile 14. The server and/or data base 24 may be a third party trusted partner system. A software agent in the vetting module 22 may be operable to make an access call to the server and/or database 24 that may automatically access the third party data base and pull trusted data that may authenticate information in the profile 14. For example, affiliations and credentials in the profile 14 may be automatically verified utilizing an employer database managed by the server and/or database 24 or utilizing a certification board's server and/or database 24 which may include lists of certified members. Employers may also proactively create and verify their employees' profiles to ensure a vetted profile exists for employees prior to an event taking place. In some examples, employers may provide automatic verifications of a member profile after a recertification event takes place, for example, Commercial Driver's License (CDL) eye test or yearly hazmat training.

The vetting module 22 may include a feature to reject credentials, certifications and/or affiliations until independent verification is provided. Credentials in the profile 14 may also include electronic proof of a certification such as scanned certification documents or links to board certification lists which may be accessed via the network 50 for example. Periodic profile 14 vetting may be used to ensure that credentials and affiliations are current and retained by the participant. In instances when a credential or affiliation has lapsed or is no longer trusted, the profile 14 may fail the vetting process and/or may be rejected.

In other examples, the vetting process may include individual or group review and/or verification of information in the profile 14 through social media means, for example, via the internet. Social media crowd sourcing techniques may enable the credentialing system 100 to develop a level of confidence or a level of trust or distrust, in information within the profile 14. The level of confidence or trust may be utilized to enhance or inform information which has been authenticated or it may provide a level of confidence when authentication from a trusted source is not utilized or available. Crowd sourcing may obtain or solicit trustworthiness contributions from a large group of users, for example, from an online community that may have access to the credentialing system 100. Users and/or trusted sources may be permitted to establish and/or augment “trustworthiness” of the profile 14 over time and as needed. For example, users of a trusted network may be allowed to track, authenticate, and/or vet the profile 14. In some systems, mobile applications may be used for this purpose.

In some systems, users with access to the credentialing system 100 may login to the profile 14. The users may view all or a portion of the profile 14. The users may indicate whether or not they agree with one or more attributes of the profile, for example, one or more credentials and/or affiliations. The greater the number of corroborating assertions received for a profile attribute may lead to a greater a level of confidence being associated with the attribute. Users may search for profiles in the database 28 based on one or more of various specified attributes, such as participant names, credentials, certifications, affiliations, employers or event history. In some systems, a user may be granted read and/or write access to the profile 14 depending on permission, for example. The profile 14 may indicate how many people have vouched for the profile or for specified attributes in the profile. When a user indicates support or lack of support for information in the profile 14 or views or modifies the profile 14, a link may be made to that user's web page, profile or information. The user providing input may be associated with a level of trust, for example, by association with other users or enterprises. For example, some of the users which provide trustworthiness information for the profile 14 may be friends of the participant 42 or friends of friends of the participant 42 in a social media network. Statistics or summaries regarding the users who have accessed the profile 14 and/or have expressed conviction regarding the validity of information in the profile 14, may be retained and/or displayed in the profile 14.

Based on the affiliations and credentials contained in a profile 14, a measure of rank, trustworthiness or credibility may be assigned to the profile 14 or to specified information within the profile. For example, in instances when each affiliation and credential listed in a profile has been verified by one or more trusted sources, the profile may obtain a relatively higher ranking 234. However, in instances when one or more affiliation and/or credential listed in a profile is not verified by a trusted source, the profile may obtain a relatively lower ranking 234 or may be rejected altogether. A relatively higher ranking may indicate a higher level of trust and may speed an event participation processing time and/or may establish an attendee as an expert in a specific field of expertise, for example. A ranking system may be used to distinguish an attendee as a novice, experienced, or an expert, based on the number and/or type of verified affiliations and credentials. Ranking may also be based on the number of events the participant has attended over a time period and/or on the types of events attended, for example. Ranking may also indicate how many unique entities, for example, people, employers or government officials, have vetted the participant's profile 14 and/or a level of credibility of entities performing a vetting process.

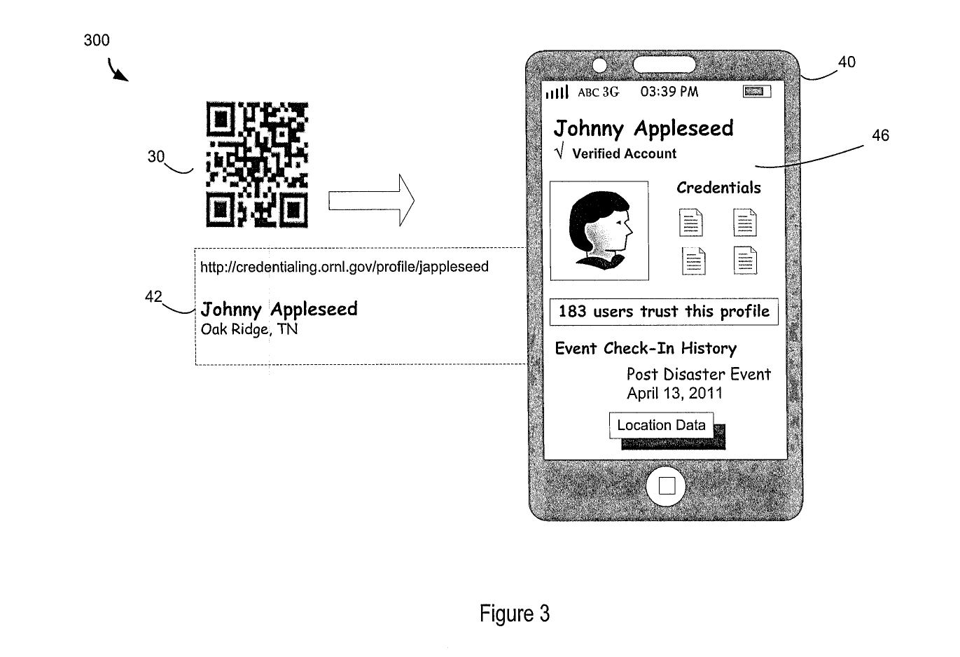

The profile 14 may be associated with a unique identifier 30, for example, when the profile 14 is created using the credentialing system modules 20, is linked from another system and/or is stored in the memory 28. In some systems, the unique identifier 30 may include a unique internet address or URL. The unique internet address may be used to access the profile 14 from one or more of the computing and/or communications systems 18, 26, 40, 12, 34 and 24 via the network 50, for example, using the Internet or another network. The identifier 30 may comprise a bar code, a Quick Response (QR) code, or some other displayable or transmittable code or symbol that may be presented for access to the profile 14. The identifier or QR code 30 may be presented in any suitable way, for example, it may be printed on paper or a business card, printed on a sticker, included on a security badge, or may electronically appear on the screen of an electronic device, for example, on a smart phone, a tablet or a laptop. In each example of the identifier or QR code presentation, a member profile 14 corresponding to the identifier or QR code 30 may be quickly accessible by simply scanning the code and accessing the member profile 14 at the unique internet address. In some systems, the corresponding participant profile 14 may be displayed as a mashup on a networked computing device screen as illustrated in FIG. 3. In one example 300, a participant 42 may attempt to gain access to an event and may present the QR code identifier 30 on a personal smart phone screen to an event sentry 40. The QR code 30 may be scanned by the computing or communication device 40 which may comprise a smart phone or a laptop, for example. A mobile application on the smart phone 40 may use the internet address from the QR code to access the profile 14 and may verify that the participant 42 has proper credentials for accessing the event. The participant 42 may be admitted to the event or may be turned away depending on the contents of their profile 14.

An event coordinator may access the credentialing system 100, via a wired or wireless internet connection, and may create a new event, or edit an existing event through an event management module, for example, the event creation module 36, the event access module 38 and/or the event status module 44. Once an event is created, the event coordinator may indicate one or more affiliations and/or credentials needed to be present in a profile 14 for admittance to the event. For example, if the event is a response to a collapsed building, then immediate access may be permitted for participants with K-9 search affiliations and credentials. After all personnel in the building at the time of collapse are accounted for, participants with heavy equipment operation credentials may then be allowed access to the site. In this example, event access control rules may change based on how much time has elapsed after an event begins or based on a progression of phases of an event. Event access control logic may reject admittance to individuals who do not have a minimum required affiliation and/or credentials needed to participate in the event at a specific time, for example. An event may be a natural disaster, a man-made event or a property or facility with a need for access control.

Admittance to an event or facility may be controlled at one or more event access points utilizing the event access module 38. The event access points may comprise a road, a door, a gate, or a checkpoint that contains a physical barrier such as a lift gate, an automatic scanner or camera and/or a human event official. The computing and/or communication device 40 may be utilized as an automatic scanner and/or may be operated by a human event official to verify a prospective participant's profile 14. The computing and/or communication device 40 may be referred to as an event sentry. The unique code 30 (e.g., QR code) may be presented or displayed by the participant 42 on a mobile device, a badge or a computer printout, for example, and may be scanned or entered into the computing and/or communication device 40. The scanning process may initiate a link via the network 50 to the computing and/or communication system 18 or 26 and/or the memory 28 and may access information from the member profile 14 of the prospective participant 42. In some systems, the scanner 40 may be a mobile device, which may use a digital camera and a mobile software application to scan the QR Code 30 and automatically access the URL address associated with the profile 14 for the participant 42 attempting to gain access to the event.

FIG. 3 illustrates an exemplary mobile application participant profile mashup which may be displayed on the computing and/or communication device 40. The actual qualification attributes 16 that may be stored in the profile 14 may be tested or matched with the affiliations and credentials that are associated with the event or required for event participants. In instances when the test is passed or there is an appropriate match, the participant 42 may be allowed access to the event. If a test fails or there is not an appropriate match to the affiliations and credentials associated with the event, then access may be held for further verification, or access may be denied altogether, for example.

If a participant is admitted to an event or attempts access to an event, the credentialing system 100 may provide an updated status through the event status module 44 to indicate that the participant has checked in and is a participant of the event or has not been admitted. The event status module 44 may log activity at an event access point and may provide an account of how many participants are on site during an event. For example, the status information may be utilized to determine equipment needs, food requirements, lodging requirements for the event. In another example, check-in and/or check-out logs may reveal a plurality of failed attempts to access an event by a user with inappropriate credentials.

A participant's exact geographical location may also be visualized, tracked, and/or coordinated using a map overlay of the event area using a GPS unit in a smart device such as a phone. In this way, event organizers, directors and various agency administrators can actively manage the participants within the event perimeter by sending messages through their own smart devices or through other communication devices such as 2-way radios or pagers for example.

In some systems, all or a portion of the functions described with respect to the credentialing system may be performed on a single device. For example, a laptop may store and/or execute instructions that perform the functions described with respect to the credentialing system modules 20 and/or may comprise a memory or database similar to the databases 28 and/or 24 for storing participant profiles, vetting profiles and/or monitoring event status. A user may utilize the laptop to, one or more of: create or link profiles, vet profiles, generate tokens, create an event, scan tokens into an event, access stored profiles and track status of the event and/or the participants. In this manner, a credentialing system 100 may be implemented with or without network connectivity.

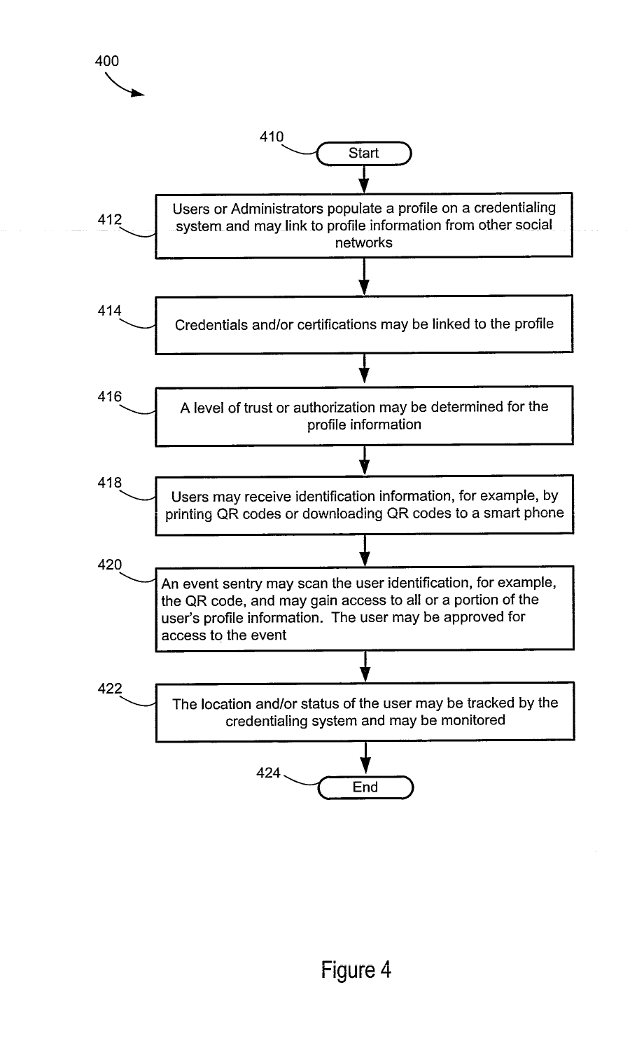

FIG. 4 is a flow diagram 400 representing exemplary steps for managing secure access to an event. Referring to FIG. 4, the exemplary steps may begin at start step 410. In step 412, a prospective event participant 42 or an administrator may populate a profile 14 for the participant on the credentialing system 100 and may link information from other social network entities. In step 414, credentials and/or certifications belonging to the participant 42 may be linked to the profile 14. In step 416, a level of trust or authorization maybe determined for all or a portion of the profile 14. In step 418, the user 42 may receive unique identification information, such as a QR code that may be printed or downloaded to a smart phone. In step 420, an event sentry 40 may scan the QR code and may gain access to all or a portion of the participant's 42 profile 14 and may grant or deny access to the event to the participant 42. In step 422, entrance and/or exit to the event by the participant 42 and/or the location and/or status of the participant 42 may be tracked and/or logged by the event status module 44.

An exemplary use case for the credentialing system 100 includes a disaster response and recovery event after a hurricane hits Coastal City, causing major damage and flooding. The Coastal City disaster event scenario may include a majority of Coastal City residents evacuated and waiting to return to their homes. Access to Coastal City may be restricted through a series of roadblocks. Short-term needs may include (1) first responders to perform search and rescue operations, (2) restoration of electricity and other utility services, (3) movement of supplies needed for recovery, (4) restoration of critical businesses to support recovery, and (5) allowing the return of residents as conditions improve.

An estimated 90% of residents are evacuated and 3% are unaccounted for and may require immediate assistance by first responders. 85% of Coastal City residents are without power. Significant debris removal is required before utility crews may access and repair electric infrastructure. Construction supplies, food, and fresh water need to be shipped into Coastal City. Shipping companies need to accept shipments and distribute supplies. Local businesses designated employees need to assess damage and provide basic services. As conditions improve, residents may be allowed to return based on location and contingent on recovery status.

Participants needing access to the Coastal City disaster event may include city government officials, first responders including fire, EMT and police, utility company service employees, shipping company employees, local business recovery support workers, volunteer relief workers and residents.

A credentialing system 100 process flow for managing the Coastal City event may include:

### A. Responders and Utility Workers:

1. City officials create an event using the event creation module 36 defining an event area and limiting initial access to responder and utility employee participants;
2. City officials create or link participant profiles using the enrollment module 10.
3. Coastal City certifies the profiles of city officials;
4. Responder and utility participants create or link profiles using the enrollment module 10 on the credentialing system 100 website and register with the event via the event access module;
5. Responder and utility organizations certify the profiles of responder and utility users;
6. Users print QR codes linking to their online profiles;
7. The city assigns National Incident Management Systems (NIMS) roles to city and responder profiles as appropriate;
9. Responder and utility participants identify needed services in the event status module 44 and the city updates access control using the event access module 38 based on emerging needs;
10. City designates an event sentry 40 to scan user QR codes and to access online profiles to verify that access control requirements are met;
11. User profiles are updated to indicate that access to event has been granted;
12. City uses a credentialing system 100 website to send messages to users registered and/or accessing the event area.

### B. Shippers and Business Workers:

1. Shipper and business employees create participant profiles on the credentialing system 100 website and register with the event;
2. Users link existing credentials and certifications to their profiles;
3. Users can flag profiles of other trusted users of the system for recruitment or credential verification;
4. Users print QR codes linking to their online profile;
5. Shipper and business companies certify employees' profiles;
6. Shipper and business participants are notified when access to the event area is available;
7. Users present QR code “electronic credential” at roadblocks and entry points of the event;
8. Designated event sentry 40 scans QR codes to access online participant profiles and verify that access control requirements are met;
9. User profiles are updated to indicate that access to the event has been granted;
10. Registered event users receive official notifications from the city as needed.

### C. Volunteer Workers and Residents:

1. Volunteers and residents create profiles on the credentialing system 100 website utilizing the enrollment module 10 and registering with the event using event access module 38;
2. Users may pre-populate their profile by linking to one or more existing social network web pages;
3. Users link existing credentials and certifications to their profile;
4. Users may flag profiles of other trusted users of the system;
5. Users print QR codes linking to their online profile;
6. Users registered with the event are notified when access to event area has been requested and/or approved by the city;
7. Users present QR code “electronic credential” at roadblocks and entry points;
8. Designated event sentry 40 scans QR codes to access online participant profiles and verify that access control requirements are met;
9. User profiles are updated to indicate that access to the event has been granted;
10. Registered event users receive official notifications from the city as needed.

A computing and/or communication system may include one or more computing apparatuses to execute a series of commands representing the method steps described herein. The computing and/or communication system may include a cloud computing environment, which may allow the one or more computing apparatuses to communicate and share information through a wired or wireless network. The one or more computing apparatuses may comprise a mainframe, a super computer, a PC or Apple Mac personal computer, a hand-held device, a smart phone, or any other apparatus having a central processing or controller unit known in the art. Each computing apparatus may be programmed with a series of instructions that, when executed, may cause the computer to perform the method steps as described and claimed in this application. The instructions that are performed may be stored on a machine-readable data storage device and may be carried out by the processing unit or controller.

The machine-readable data storage device may be a portable memory device that may be readable by each computing apparatus. Such portable memory device may be a compact disk (CD), digital video disk (DVD), a Flash Drive, any other disk readable by a disk driver embedded or externally connected to a computer, a memory stick, or any other portable storage medium currently available or yet to be invented. Alternately, the machine-readable data storage device can be an embedded component of a computing apparatus such as a hard disk or a flash drive.

The computing apparatus and machine-readable data storage device can be a standalone device or a device that is imbedded into a machine or other system, such as a cloud, that uses the instructions for a useful result.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of managing an event, the method comprising the steps of:
enrolling one or more prospective participants, wherein each participant is associated with a corresponding participant profile which is stored in a device memory, each participant profile including one or more attributes;
assigning a unique token to each of the participant profiles for allowing electronic access to corresponding ones of the participant profiles;
determining a level of trust in one or more of the attributes of each of the participant profiles;
creating an event that is stored in a memory device wherein one or more access control rules are associated with the event, the one or more access control rules identifying one or more attributes used for allowing access to the event; and
controlling access to the event by scanning a prospective participant's unique token with a scanning device and accessing the participant profile corresponding to the unique token and testing one or more of the attributes stored in the accessed participant profile, relative to the one or more access control rules associated with the event.

2. The method steps as recited in claim 1 wherein the one or more attributes includes one or more of a photo, a name, physical attributes, a social security number, a street address, a company affiliation, a professional certification, a local certification, a state certification, a federal certification, a professional license, a degree, a permit, a skill and a specific piece of equipment.

3. The method steps as recited in claim 1, wherein the participant profile is accessible via the Internet or another network.

4. The method steps as recited in claim 1, wherein the one or more of the attributes are linked into the participant profile from a networked device.

5. The method steps as recited in claim 1, wherein the accessed participant profile is displayed as a mashup on a networked computing device screen.

6. The method steps as recited in claim 1, wherein the determination of the level of trust is performed automatically by accessing a networked device.

7. The method steps as recited in claim 1, wherein the participant profile or one or more of the attributes are authenticated by a third party vetting process through a network.

8. The method steps as recited in claim 1, wherein the determination of the level of trust is performed by social networking means via a network.

9. The method steps as recited in claim 1, wherein the one or more access control rules that are associated with the event vary over time or vary based on various locations of the event.

10. The method steps as recited in claim 1, wherein the unique token is reusable to gain access to one or more other events which are associated with one or more different access control rules.

11. The method steps as recited in claim 1, wherein the enrolling step also includes purchasing a permit.

12. The method steps as recited in claim 1, wherein the unique token is a Quick Response (QR) Code.

13. The method steps as recited in claim 1, further comprising tracking the participant's location via a global positioning sensor.

14. The method steps as recited in claim 1, wherein messages are sent to the one or more enrolled participants.

15. The method steps as recited in claim 1, wherein the event is one or more of a scheduled event, an ad hoc event, a manmade event, a natural disaster response, a sporting event, an artistic event, access to a physical facility, access to a property or access to a geographic area.

16. A system for managing an event, the system comprising one or more circuits or processors, the one or more circuits or processors being operable to:
enroll one or more prospective participants, wherein each participant is associated with a corresponding participant profile which is stored in a device memory, each participant profile including one or more attributes;
assign a unique token to each of the participant profiles for allowing electronic access to corresponding ones of the participant profiles;
determine a level of trust in one or more of the attributes of each of the participant profiles;
create an event that is stored in a memory device wherein one or more access control rules are associated with the event, the one or more access control rules identifying one or more attributes used for allowing access to the event; and
control access to the event by scanning a prospective participant's unique token with a scanning device and accessing the participant profile corresponding to the unique token and testing one or more of the attributes stored in the accessed participant profile, relative to the one or more access control rules associated with the event.

17. The system according to claim 16, wherein the one or more attributes includes one or more of a photo, a name, physical attributes, a social security number, a street address, a company affiliation, a professional certification, a local certification, a state certification, a federal certification, a professional license, a degree, a permit, a skill and a specific piece of equipment.

18. The system according to claim 16, wherein the participant profile is accessible via the Internet or another network.

19. The system according to claim 16, wherein the one or more of the attributes are linked into the participant profile from a networked device.

20. The system according to claim 16, wherein the accessed participant profile is displayed as a mashup on a networked computing device screen.

21. The system according to claim 16, wherein the determination of the level of trust is performed automatically by accessing a networked device.

22. The system according to claim 16, wherein the participant profile or one or more of the attributes are authenticated by a third party vetting process through a network.

23. The system according to claim 16, wherein the determination of the level of trust is performed by social networking means via a network.

24. The system according to claim 16, wherein the one or more access control rules that are associated with the event vary over time or vary based on various locations of the event.

25. The system according to claim 16, wherein the unique token is reusable to gain access to one or more other events which are associated with one or more different access control rules.

26. The system according to claim 16, wherein the enrolling step also includes purchasing a permit.

27. The system according to claim 16, wherein the unique token is a Quick Response (QR) Code.

28. The system according to claim 16, further comprising tracking the participant's location via a global positioning sensor.

29. The system according to claim 16, wherein messages are sent to the one or more participants.

30. The system according to claim 16, wherein the event is one or more of a scheduled event, an ad hoc event, a manmade event, a natural disaster response, a sporting event, an artistic event, access to a physical facility, access to a property or access to a geographic area.

31. A networked computer system for managing an event, the computer system comprising:
a processing device;
a memory device in communication with the processing device, the memory device configured for storing processing device executable instructions, wherein the processing device executable instructions include:
an enrollment module for generating, and storing into memory, one or more prospective participant profiles having one or more qualification attributes, the module also for generating a unique token for allowing direct access to a unique participant profile;
a vetting module for verifying one or more of the qualification attributes in each unique participant profile stored in memory to ensure the prospective participant has attained and retained the qualification attributes;
an event manager module for creating an event that is stored in the memory of a computing device in the network, the event having one or more access control rules defined, the rules requiring that one or more specific qualification attributes be present and authenticated in a participant profile in order for the rules to be met and for a prospective participant to be eligible for event participation; and
an access control module for controlling access to the event by scanning a prospective participant's unique token code with a networked scanning device and matching the one or more professional attributes stored in the unique participant profile with the one or more access control rules stored for the event.
